(19) United States
(12) Patent Application Publication
(10) Pub. No.: US 2025/0273380 A1
(43) Pub. Date: Aug. 28, 2025

(54) IRON CORE AND CONTACTOR

(71) Applicant: Schneider Electric Industries SAS, Rueil-Malmaison (FR)

(72) Inventors: Yuanzhong Wang, Shanghai (CN); Zhiping Huan, Shanghai (CN); Yonglu Xue, Shanghai (CN); Tao Liu, Shanghai (CN); Xu Han, Shanghai (CN); Shaofan Li, Shanghai (CN)

(73) Assignee: Schneider Electric Industries SAS, Rueil-Malmaison (FR)

(21) Appl. No.: 19/038,078

(22) Filed: Jan. 27, 2025

(30) Foreign Application Priority Data
Feb. 22, 2024 (CN) 2024101994342

(51) Int. Cl. H01F 27/245

(52) U.S. Cl. CPC H01F 27/245

(57) ABSTRACT

An iron core for a contactor and a contactor. The iron core includes an iron core body, the iron core body includes a plurality of silicon steel sheets fixed together by lamination, the iron core body further includes a metal rod, the metal rod penetrates and is fixed to at least some of the plurality of silicon steel sheets, and a material of the metal rod is one or more selected from the group consisting of aluminum, aluminum alloy, magnesium, magnesium alloy, zinc and zinc alloy.

The present application claims the priority and benefits of the Chinese Patent Applications No. 202410199434.2, which was filed on Feb. 22, 2024, the disclosure of which is incorporated herein by reference in its entirety as part of the present application.

### TECHNICAL FIELD

The present application relates to an iron core for a contactor and a contactor including the iron core.

### BACKGROUND

When the contactor is used in salt fog environment, the iron core (including movable iron core and stationary iron core) of the contactor will be corroded by salt fog. In order to reduce the corrosion of the iron core, in the existing art, an anti-rust layer is plated on the surface of the iron core, however, this leads to an increase in the air gap between the movable iron core and the stationary iron core in the closed state, thus leading to a decrease in the retention force. In the existing art, the surface of the iron core is also coated with oil, which reduces the cost, but in the closed state of the movable iron core and the stationary iron core, there is still a problem that the air gap between the movable iron core and the stationary iron core is increased, which leads to the decrease of the retention force.

Therefore, there is a need for an iron core of a contactor, which can reduce the corrosion of the iron core caused by the salt fog environment without increasing the air gap between the movable iron core and the stationary iron core.

### SUMMARY

In order to solve the abovementioned problems, the present application provides an iron core for a contactor, which includes an iron core body including a plurality of silicon steel sheets fixed together by lamination, the iron core body further includes a metal rod, the metal rod penetrates and is fixed to at least some of the plurality of silicon steel sheets, and a material of the metal rod is one or more selected from the group consisting of aluminum, aluminum alloy, magnesium, magnesium alloy, zinc and zinc alloy.

Advantageously, the metal rod penetrates and is fixed to all silicon steel sheets among a plurality of silicon steel sheets.

Advantageously, the iron core body further comprises a steel rivet for penetrating the plurality of silicon steel sheets to fixedly connect the plurality of silicon steel sheets.

Advantageously, the iron core is a movable iron core comprising a first part extending in a first direction and a second part extending in a second direction perpendicular to the first direction, and the movable iron core is movable in the second direction.

Advantageously, the metal rod is disposed in the second part.

Advantageously, the iron core is a stationary iron core comprising a first part extending in a first direction and two second parts extending in a second direction perpendicular to the first direction and located at both ends of the first part.

Advantageously, the stationary iron core further comprises extension parts extending towards each other in the first direction from ends of the two second parts away from the first part, respectively, so as to form a gap between the two extension parts.

Advantageously, the metal rod is arranged at a joint of the first part and the second part.

The present application further provides a contactor, which includes the abovementioned iron core.

### BRIEF DESCRIPTION OF DRAWINGS

The above and other features and advantages of the exemplary embodiments of the present disclosure will become more apparent from the following detailed description taken in conjunction with the accompanying drawings, which are for illustrative purposes only and are not intended to limit the scope of the present disclosure in any way, wherein:

FIG. 1 shows a perspective view of a contactor according to the present application

### DETAILED DESCRIPTION

In order to make the purpose, technical solution and advantages of the technical solution of the present disclosure more clear, the technical solution of the embodiment of the present disclosure will be described clearly and completely with the accompanying drawings of specific embodiments of the present disclosure. Like reference numerals in the drawings represent like parts. It should be noted that the described embodiment is a part of the embodiments of the present disclosure, not all embodiments. Based on the described embodiments of the present disclosure, all other embodiments obtained by ordinary skilled in the field without creative labor belong to the scope of protection of the present disclosure.

Compared with the embodiment shown in the attached drawings, the feasible embodiments within the protection scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by people with ordinary skills in the field to which the present disclosure belongs. The words “first”, “second” and similar words used in the description and claims of the patent application of the present disclosure do not indicate any order, quantity or importance, but are only used to distinguish different components. When the number of components is not specified, the number of components can be one or more; similarly, similar words such as “a”, “an” and “the” do not necessarily mean quantity limitation. Similar words such as “including” or “comprising” refer to that the elements or objects appearing before the word cover the elements or objects listed after the word and their equivalents, without excluding other elements or objects. “Up”, “Down”, “Left” and “Right” are only used to indicate the relative orientation relationship when the equipment is used or the orientation relationship shown in the attached drawings. When the absolute position of the described object changes, the relative orientation relationship may also change accordingly.

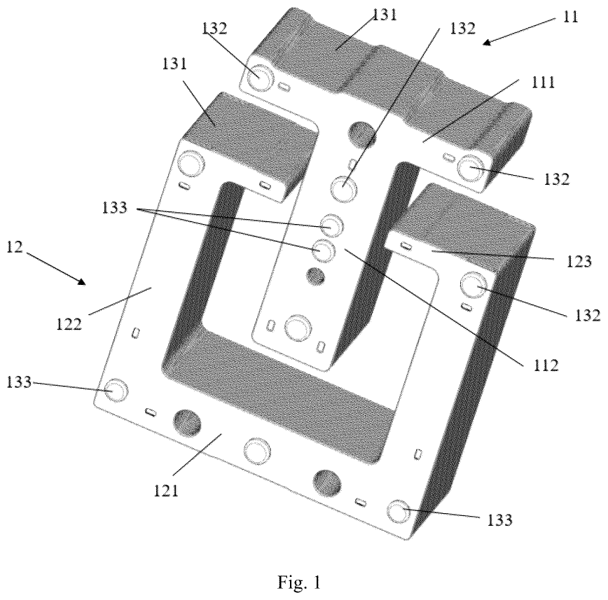

FIG. 1 shows a perspective view of a contactor according to the present application. The contactor can be used in a salt fog environment. The contactor includes a movable iron core 11 and a stationary iron core 12, and the movable iron core can move between a closed position and a separated position; in the closed position, the movable iron core is in contact with the stationary iron core, and, in the separated position, the movable iron core is separated from the stationary iron core.

The movable iron core 11 and the stationary iron core 12 can be collectively referred to as “iron core”. In this case, both the movable iron core 11 and the stationary iron core 12 include an iron core body, and the iron core body includes a plurality of silicon steel sheets 131 which are laminated together and fixedly connected together by steel rivets 132. The steel rivets 132 are arranged at appropriate positions and may have an appropriate number. The iron core also comprises a metal rod 133, and the material of the metal rod 133 is one or more selected from the group consisting of aluminum, aluminum alloy, magnesium, magnesium alloy, zinc and zinc alloy.

The metal rod 133 penetrates and is fixed to all the silicon steel sheets in the plurality of silicon steel sheets. The iron core body is also provided with a steel rivet for penetrating the plurality of silicon steel sheets to fixedly connect the plurality of silicon steel sheets.

The movable iron core 11 includes a first part 111 extending in a first direction and a second part 112 extending in a second direction perpendicular to the first direction, and the movable iron core can move towards and away from the stationary iron core in the second direction. The metal rod 133 is disposed in the second part 112.

The stationary iron core 12 includes a first part 121 extending in a first direction and two second parts 122 extending in a second direction perpendicular to the first direction and located at both ends of the first part.

The stationary iron core further includes extension parts 123 extending toward each other in the first direction from the ends of the two second parts away from the first part, respectively, so as to form a gap between the two extension parts. The second part of the movable iron core can extend through the gap, so that the first part of the movable iron core is opposite to the extension part.

The metal rod 133 is arranged at the joint of the first part and the second part of the stationary iron core. However, the position of the metal rod 133 is not limited thereto, and an appropriate position can be selected as required. Similarly, an appropriate number of metal rods can also be selected.

Through the metal rod 133 of the present application, when the contactor is used in a salt fog environment, the metal rod can form a sacrificial anode, so that chloride ions in the salt fog environment will preferentially react with the metal rod and release electrons. These electrons are transferred to the silicon steel sheets through salt fog solution, thus forming cathodic protection and reducing the corrosion of silicon steel sheets. In addition, the movable iron core and the stationary iron core do not need to be electroplated with a coating layer or coated with any antirust oil, which will not reduce the retention force.

Although the present disclosure has been described in the specification and illustrated in the drawings on the basis of referring to various embodiments, those skilled in the art can understand that the above-mentioned embodiments are only preferred embodiments, and some technical features in the embodiments may not be necessary for solving specific technical problems, so these technical features may not be needed or omitted without affecting the solution of technical problems or the formation of technical solutions. Moreover, the features, elements and/or functions of one embodiment can be combined, cooperated or coordinated with those of one or more other embodiments as appropriate, unless the combination, cooperation or coordination is obviously impracticable.

1. An iron core for a contactor, comprising an iron core body comprising a plurality of silicon steel sheets fixed together by lamination, wherein the iron core body further comprises a metal rod, the metal rod penetrates and is fixed to at least some of the plurality of silicon steel sheets, and a material of the metal rod is one or more selected from the group consisting of aluminum, aluminum alloy, magnesium, magnesium alloy, zinc and zinc alloy.

2. The iron core according to claim 1, wherein the metal rod penetrates and is fixed to all silicon steel sheets of the plurality of silicon steel sheets.

3. The iron core according to claim 1, wherein the iron core body further comprises a steel rivet for penetrating the plurality of silicon steel sheets to fixedly connect the plurality of silicon steel sheets.

4. The iron core according to claim 1, wherein the iron core is a movable iron core comprising a first part extending in a first direction and a second part extending in a second direction perpendicular to the first direction, and the movable iron core is movable in the second direction.

5. The iron core according to claim 4, wherein the metal rod is disposed in the second part.

6. The iron core according to claim 1, wherein the iron core is a stationary iron core comprising a first part extending in a first direction and two second parts extending in a second direction perpendicular to the first direction and located at both ends of the first part.

7. The iron core according to claim 6, wherein the stationary iron core further comprises extension parts extending towards each other in the first direction from ends of the two second parts away from the first part, respectively, so as to form a gap between the two extension parts.

8. The iron core according to claim 6, wherein the metal rod is arranged at a joint of the first part and the second part.

9. A contactor, comprising the iron core according to claim 1.
